(19) United States
(12) Patent Application Publication
(10) Pub. No.: US 2005/0225984 A1
(43) Pub. Date: Oct. 13, 2005

(54) Electrical light sources

(76) Inventor: Henry Oliver Theobald, Weybridge (GB)

Correspondence Address: STITES & HARBISON PLLC, 1199 NORTH FAIRFAX STREET, SUITE 900, ALEXANDRIA, VA, 22314, US

(21) Appl. No.: 10/836,623

(22) Filed: May 3, 2004

(30) Foreign Application Priority Data
Apr. 2, 2004 (GB) 0407604.8

(51) Int. Cl. F21V 33/00

(52) U.S. Cl. 362/276

(57) ABSTRACT

The invention relates to a light source 1, the intensity of illumination of which can be adjusted by means of a device 3 sensitive to changes in air pressure such as a piezoelectric device. Such a light source 1 can be used in an artificial candle.

The invention relates to electrical light sources and particularly, but not exclusively, to electrical light sources in artificial candles.

Electrical light sources are often controlled to vary the intensity of illumination of the light source. An example is an electrical rheostat. In an artificial candle, where the light source is controlled to provide a flickering effect, a manually operated electrical switch may be provided to switch off the light source.

According to the invention, there is provide an electrical light comprising a light source and a device sensitive to changes in air pressure, the device, on sensing a predetermined change in air pressure, controlling the light source to change the intensity of illumination of the light source.

In this way, the intensity of illumination can be controlled by a person blowing on the device.

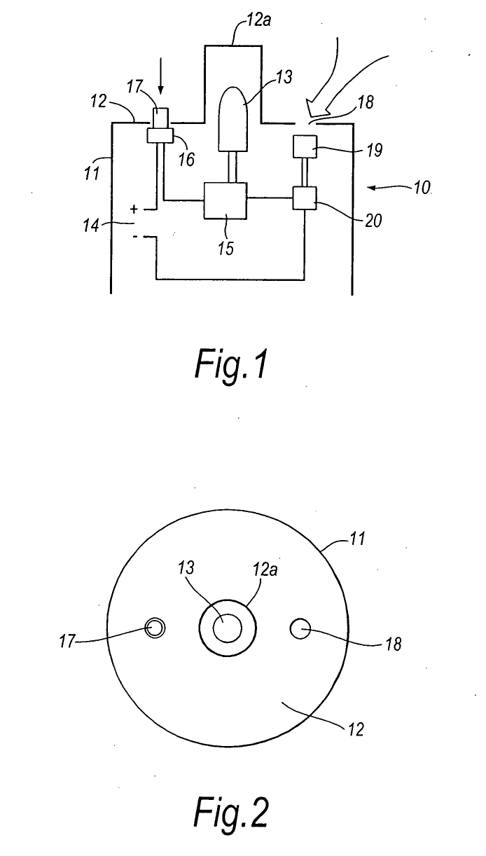

Referring first to FIGS. 1 and 2, the artificial candle comprises a generally cylindrical body 10 which may be made from a white plastics material that may be translucent. The body 10 comprises a generally cylindrical shell 11 closed at one end by an end wall 12. The end wall 12 is formed with central upstanding cylindrical housing 12a that accommodates a light source 13. The housing 12a is translucent and may provide a suitably coloured filter.

The light source 13 may be a light bulb or a light emitting diode or any other suitable light emitting device. The light source 13 is connected to a power source 14, such as a battery, via a control system 15 and a first switch 16. The control system 15 controls the light source 13 to provide a flickering effect to emulate a candle. The first switch 16 includes an operating buffer 17 that project through the end wall 12.

The end wall also includes a hole 18 beneath which is a pressure sensitive device 19, which may be in the form of a piezo-electric device. The pressure sensitive device 19 is connected to a second switch 20 in the circuit controlling the light source 13.

In use, the first switch 16 is operated by pressing the button 17 to illuminate the light source 13 to provide the flickering candle-emulating effect. When it is desired to switch off the candle, a person blows through the hole 18. The pressure sensitive device 19 senses the change in air pressure as being above a predetermined minimum and produces an electrical signal that is fed to the second switch 20. This switches off the light source 13 and then re-sets so allowing the light source 13 to be switched on again using the first switch 16.

In this way, the artificial candle can be blown out in the same way as a real candle.

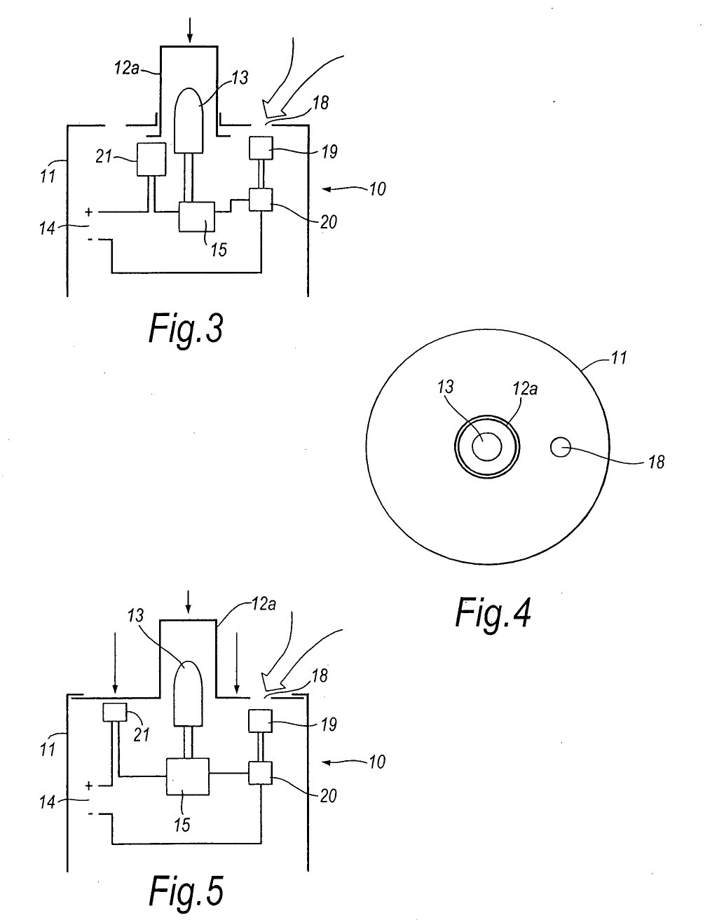

A modified form of the artificial candle of FIGS. 1 and 2 in shown in FIGS. 3 and 4. Parts common to FIGS. 3 and 4 and to FIGS. 1 and 2 are given the same reference numerals and will not be described in detail.

In the embodiment of FIGS. 3 and 4, the cylindrical housing 12a is movable relative to the end wall 12 in a direction parallel to the axis of the shell 11. The housing 12a is spring loaded urging it outwardly of the end wall 12. The light source 13 moves with the housing 12a. Depression of the housing 12a operates a switch 21, which replaces the first switch 16, and acts to switch on the light source 13. The artificial candle of FIGS. 2 and 3 operates otherwise in the same way as the artificial candle of FIGS. 1 and 2.

A further modified form of the artificial candle of FIGS. 1 and 2 is shown in FIG. 5. Parts common to FIG. 5 and to FIGS. 1 and 2 are given the same reference numerals and will not be described in detail.

In the embodiment of FIG. 5, the end wall 12 is movable relative to the shell 11 in a direction parallel to the axis of the shell 11. The end wall 12 is spring loaded urging it outwardly of the shell 11. The light source 13 moves with the end wall 12. Depression of the end wall 12, which may be achieved by pressure on the housing 12a, acts to switch on the light source 13. On release, the end wall 12 returns under the action of the spring to its rest position. The artificial candle of FIG. 5 operates otherwise in the same way as the artificial candle of FIGS. 1 and 2.

It will be appreciated that blowing on the pressure sensitive device 19 need not turn the light source 13 off. It could incrementally increase or decrease the intensity of illumination of the source between the source 13 being out, or nearly out, and full illumination. The pressure sensitive device 19 will be calibrated so that small changes in air pressure, such as occur naturally in the atmosphere, do not result in any change of the light source 13 but only pressure changes caused by blowing achieve that effect.

The end wall 12, including the housing 12a, may be covered in a flexible protection material (not shown) to prevent the egress of contamination into the shell 11. The candle may be of any suitable size or shape.

The arrangement described above with reference to the drawings need not be used with an artificial candle. It could be used with any light source to control the intensity of illumination.

The arrangement described above could also be included in a novelty card, for example, a birthday or Christmas card. Such a card could include a light source in the form of an artificial candle. The arrangement could be in a flattened form for such a use. If the card is one which opens, the opening of the card could actuate a switch for illuminating of the light source.

1. An electrical light comprising a light source and a device sensitive to changes in air pressure, the device, on sensing a predetermined change in air pressure, controlling the light source to change the intensity of illumination of the light source.

2. A light according to claim 1 wherein the light source forms an artificial flame for an artificial candle, control means controlling the light source to flicker, to emulate a candle, operation of the pressure sensitive device switching off the light source.

3. A light according to claim 1 wherein the pressure-sensitive device is a piezoelectric device.

4. A light according to claim 1 wherein the pressure sensitive device is connected to a switch controlling the supply of power to the light source, the pressure sensitive device, when said pressure is varied, causing the switch to change the intensity of illumination of the light source.

5. A light according to claim 4 wherein said switch switches off the light source.

6. A light according to claim 1 and further comprising a switch for switching on the light source.

7. A light according to claim 6 wherein the light source is moveable to operate said switch.

8. A light according to claim 1 including a housing carrying said light source and said pressure sensitive device, a hole being provided in said housing to allow the passage of air to the pressure-sensitive device.

9. A light according to claim 8 including a switch for switching on the light source wherein the housing comprises a first portion and a second portion, the first portion holding the light source and being moveable relative to the second portion to operate said switch.

10. A light according to claim 9 wherein the first portion comprises an end wall including a housing covering the light source and the second portion comprises a substantially cylindrical body closed at one end by the end wall, the housing, and the light source extending through the remainder of the end wall and being moveable relative thereto to operate said switch.

11. An arrangement according to claim 9 wherein the first portion comprises an end wall including a housing covering the light source, the second portion comprising a cylindrical body closed an one end by the end wall, the end wall and the light source being moveable relative to said second portion to operate said switch.

12. A light according to any one of claim 10 wherein the first portion is spring loaded, the first portion and the light source being moveable against said spring loading to operate said switch.

13. An arrangement according to claim 9 wherein at least the first portion is made from a translucent or transparent material.

14. An arrangement according to claim 8 and further comprising a switch for switching on the light source wherein said hole is formed in said end wall.

15. An arrangement according to claim 8 wherein the housing is at least partially coated in a flexible material.

16. An arrangement according to claim 9 wherein said light source is an elongate light source extending generally axially relative to the second portion.

17. A card including the arrangement according to claim 1.
